(19) United States
(12) Patent Application Publication
(10) Pub. No.: US 2006/0197866 A1
(43) Pub. Date: Sep. 7, 2006

(54) Image taking apparatus

(75) Inventor: Shinichi Fujimoto, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/355,163

(22) Filed: Feb. 16, 2006

(30) Foreign Application Priority Data
Mar. 1, 2005 (JP) 2005-056452

(51) Int. Cl. H04N 5/235

(52) U.S. Cl. 348/362

(57) ABSTRACT

The present invention provides an image taking apparatus which determines an exposure from a photometry result in accordance with a program chart and takes an image by exposing an image sensor to light with the determined exposure. The image taking apparatus includes a motion detection device which detects motion of an image taken by the image sensor on the basis of images continuously taken by the image sensor, and a program chart switching device which switches between program charts depending on a magnitude of motion detected by the motion detection device such that a shutter speed becomes faster with respect to a single photometry result.

### BACKGROUND OF THE INVENTION

1. Field of the Invention

The present invention relates to an image taking apparatus and, more particularly, to an image taking apparatus which determines an exposure on the basis of a predetermined program chart.

2. Description of the Related Art

Many of failed photographs are caused by a camera shake. As a function of preventing such a failed photograph caused by a camera shake, a camera-shake compensation function is known. There are available several camera-shake compensation methods. For example, in lens-shift type camera-shake compensation, a gyro sensor detects any vertical or horizontal vibration, and part of a lens is translated in the same direction as that of the vibration, thereby optically correcting blurring.

As one of camera autoexposure (AE) modes, Program AE is known. In this Program AE, the optimal f-number and shutter speed are automatically determined from the brightness of a subject on the basis of a predetermined program chart.

Japanese Patent Application Laid-Open No. 3-150540 proposes switching between program charts in conjunction with the ON/OFF of a camera-shake compensation device in a camera which adopts this Program AE. Japanese Patent Application Laid-Open No. 9-80534 proposes switching between program charts depending on the state of image blurring detected by an angular velocity sensor.

### SUMMARY OF THE INVENTION

However, if a camera-shake compensation device is incorporated in a camera, as described in Japanese Patent Application Laid-Open No. 3-150540 and Japanese Patent Application Laid-Open No. 9-80534, the parts count increases. This is disadvantageous in that the cost and size of the camera increase.

The present invention has been made in consideration of the above-described circumstances, and has as its object to provide an image taking apparatus which can effectively prevent image blurring with simple configuration.

To achieve the object, the present invention provides an image taking apparatus which determines an exposure from a photometry result in accordance with a program chart and takes an image by exposing an image sensor to light with the determined exposure, comprising a motion detection device which detects motion of an image taken by the image sensor on the basis of images continuously taken by the image sensor, and a program chart switching device which switches between program charts depending on a magnitude of motion detected by the motion detection device such that a shutter speed becomes faster with respect to a single photometry result.

According to the image taking apparatus of the present invention, motion of an image taken by the image sensor is detected on the basis of images continuously taken by the image sensor. Switching between program charts is performed depending on a magnitude of the detected motion such that a shutter speed becomes faster with respect to a single photometry result.

In the present invention, it is preferable that the motion detection device detects the motion of the image taken by the image sensor on the basis of a difference between an image of a current frame and an image of an immediately preceding frame taken by the image sensor.

According to this aspect, the motion detection device detects motion of an image taken by the image sensor on the basis of a difference between an image of a current frame and an image of an immediately preceding frame taken by the image sensor.

In the present invention, it is also preferable that a plurality of program charts to be selected depending on a magnitude of motion detected by the motion detection device are prepared.

According to this aspect, a plurality of program charts to be selected depending on a magnitude of motion detected by the motion detection device are prepared.

According to the image taking apparatus of the present invention, it is possible to effectively prevent image blurring with simple configuration.

### BRIEF DESCRIPTION OF THE DRAWINGS

FIG. 1 is a block diagram showing the electrical configuration of a digital camera to which the present invention is applied;

FIGS. 2A and 2B are charts showing examples of a program chart; and

FIG. 3 is a flowchart showing the procedure for processing operation of the digital camera at the time of photography.

### DETAILED DESCRIPTION OF THE PREFERRED EMBODIMENT

The best mode for carrying out an image taking apparatus according to the present invention will be explained in detail below with reference to the accompanying drawings.

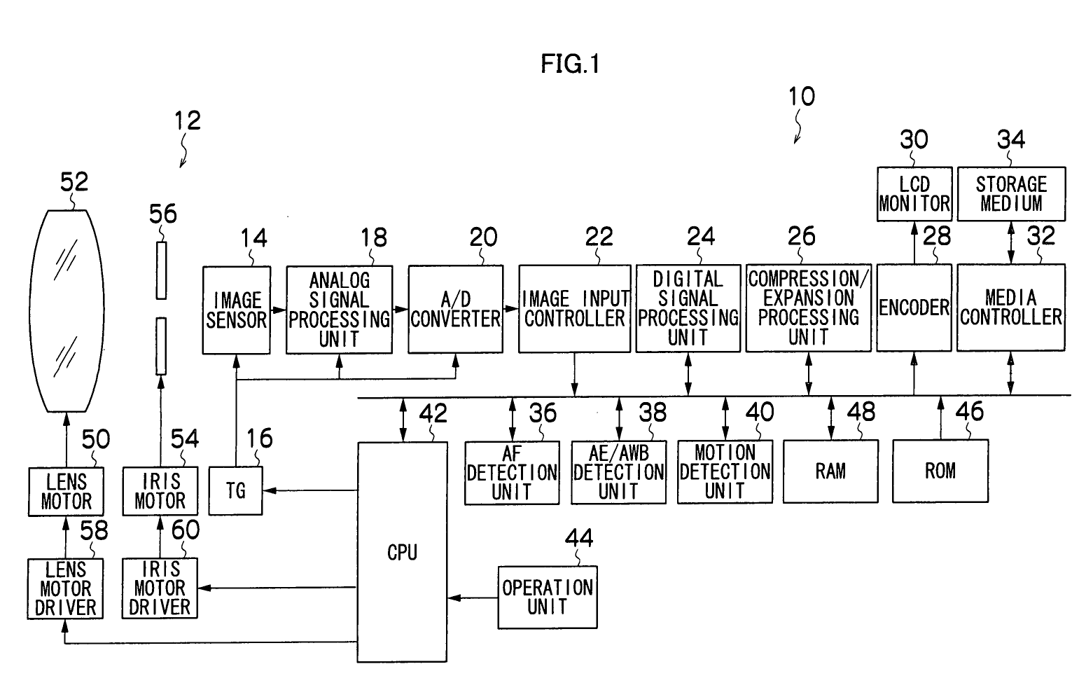

FIG. 1 is a block diagram showing the electrical configuration of a digital camera 10 to which the present invention is applied. As shown in FIG. 1, the digital camera 10 of this embodiment is composed of a photographic optical system 12, an image sensor 14, a timing generator (TG) 16, an analog signal processing unit 18, an A/D converter 20, an image input controller 22, a digital signal processing unit 24, a compression/expansion processing unit 26, an encoder 28, a LCD monitor 30, a media controller 32, a storage medium 34, an AF detection unit 36, an AE/AWB detection unit 38, a motion detection unit 40, a CPU 42, an operation unit 44, an ROM 46, an RAM 48, and the like.

The overall operation of the digital camera 10 is collectively controlled by the CPU 42. The CPU 42 controls units of the digital camera 10 on the basis of an input from the operation unit 44 in accordance with a predetermined control program. The control program to be executed by the CPU 42 and various types of data (e.g., a program chart) required for the control are recorded on the ROM 46. The CPU 42 loads the control program stored in the ROM 46 into a predetermined area of the RAM 48 and performs various types of processing using the RAM 48 as a work area. Note that the operation unit 44 includes a power switch, a shutter button, a mode selector switch, and the like and outputs a signal corresponding to operation to the CPU 42.

The photographic optical system 12 is composed of a photographic lens 52 whose focal position changes when driven by a lens motor 50 and an iris 56 whose f-number changes stepwise when driven by an iris motor 54. The CPU 42 performs focus control by controlling driving of the lens motor 50 through a lens motor driver 58 and performs iris control by controlling driving of the iris motor through an iris motor driver 60.

The image sensor 14 is composed of a primary-color CCD with a predetermined filter array, and many photodiodes are two-dimensionally arranged on its light-receiving surface. Light of a subject having passed through the photographic optical system 12 is received by the photodiodes and converted into signal charges corresponding to the amount of the incident light. Signal charges accumulated in the photodiodes are sequentially read out as voltage signals (image signals) corresponding to the signal charges in response to a driving pulse supplied from the timing generator 16 and applied to the analog signal processing unit 18.

The analog signal processing unit 18 includes a CDS (Correlated Double Sampling), AGC (Gain Control Amplifier), and the like. The analog signal processing unit 18 performs correlated double sampling processing and amplification for image signals output on an RGB dot sequential basis from the image sensor 14 and outputs the signals to the A/D converter 20.

The A/D converter 20 converts an analog image signal output from the analog signal processing unit 18 into a digital signal and outputs it. The digital image signal output from the A/D converter 20 is taken into a predetermined storage area of the RAM 48 through the image input controller 22.

The digital signal processing unit 24 includes a synchronization circuit (processing circuit which interpolates a spatial shift in a color signal caused by the color filter array of the single-CCD and converts the color signal into a synchronous one), a white balance correction circuit, a gamma correction circuit, an edge correction circuit, a color-difference matrix circuit, and the like. The digital signal processing unit 24 processes an input image signal using the RAM 48 in accordance with an instruction from the CPU 42 and generates YUV data composed of luminance data and color-difference data.

When an image taken by the image sensor 14 is to be displayed on the LCD monitor 30, YUV data generated by the digital signal processing unit 24 is output to the LCD monitor 30 through the encoder 28. With this operation, the image taken by the image sensor 14 is displayed on the LCD monitor 30.

When an image taken by the image sensor 14 is to be recorded on the storage medium 34, YUV data generated by the digital signal processing unit 24 is compressed in a predetermined compression format by the compression/expansion processing unit 26 and recorded on the storage medium 34 through the media controller 32.

When YUV data recorded on the storage medium 34 is to be played back, compressed YUV data read out from the storage medium 34 is expanded by the compression/expansion processing unit 26 and output to the LCD monitor 30 through the encoder 28. With this operation, an image recorded on the storage medium 34 is played back and displayed on the LCD monitor 30.

The AF detection unit 36 calculates a physical quantity necessary for AF control from an image signal received from the image input controller 22 in accordance with an instruction from the CPU 42. Assume that the digital camera 10 of this embodiment performs AF control using the contrast of an image. The AF detection unit 36 calculates a focus evaluation value indicating the sharpness of an image from an input image signal. The CPU 42 controls driving of the lens motor driver 58 such that the focus evaluation value calculated by the AF detection unit 36 becomes maximum.

The AE/AWB detection unit 38 calculates physical quantities necessary for AE control and AWB control from an image signal received from the image input controller 22 in accordance with an instruction from the CPU 42.

For example, one screen is divided into a plurality of areas (e.g., 16×16 areas), and the integrated value of R, G, B image signals is calculated for each of the divided areas as a physical quantity necessary for AE control. The CPU 42 calculates the brightness (EV value) of a subject on the basis of the integrated value obtained from the AE/AWB detection unit 38. The f-number and shutter speed are determined from the calculated EV value on the basis of a predetermined program chart. Note that the program chart to be referred to is determined depending on motion (image blurring) of an image being taken by the image sensor 14, as will be described later.

One screen is divided into a plurality of areas (e.g., 16×16 areas), and the average value of the integrated values for the respective colors of R, G, B image signals is calculated for each of the divided areas as a physical quantity necessary for AWB control. The CPU 42 calculates the ratio of R/G and that of B/G for each of the divided areas from the obtained integrated value for R, that for B, and that for G and determines a light source type on the basis of, e.g., distributions of the calculated ratios of R/G and B/G in R/G and B/G color spaces. The CPU 42 determines a gain value (white balance correction value) for R, G, B signals of a white balance adjustment unit in accordance with a white balance adjustment value suitable for the determined light source type such that each ratio is approximately 1 (i.e., the ratio among the integrated values for RGB in one screen≅1:1:1).

The motion detection unit 40 calculates a difference between an image of the immediately preceding frame and an image of the current frame of images continuously taken by the image sensor 14. The motion detection unit 40 comprises a buffer memory and difference computing unit, and pieces of YUV data of images continuously taken by the image sensor 14 are recorded in the buffer memory on a FIFO basis. The motion detection unit 40 sequentially reads out the pieces of YUV data recorded in the buffer memory and supplies them to the difference computing unit. The motion detection unit 40 calculates a difference (difference value) between an image of the immediately preceding frame and an image of the current frame and outputs it to the CPU 42. The CPU 42 detects motion (image blurring) of an image being taken by the image sensor 14 on the basis of the difference value obtained from the motion detection unit 40. The CPU 42 then determines a program chart to be used for Program AE on the basis of the detected motion of the image. More specifically, the CPU 42 determines whether the difference value obtained from the motion detection unit 40 exceeds a preset threshold value. If it is determined that the difference value exceeds the threshold value, the CPU 42 determines that there is any motion (image blurring) and refers to a program chart for a case where there is any motion at the time of AE. On the other hand, if it is determined that the difference value obtained from the motion detection unit 40 does not exceed the preset threshold value, the CPU 42 determines that there is no motion (image blurring) and refers to a program chart for a case where there is no motion at the time of AE.

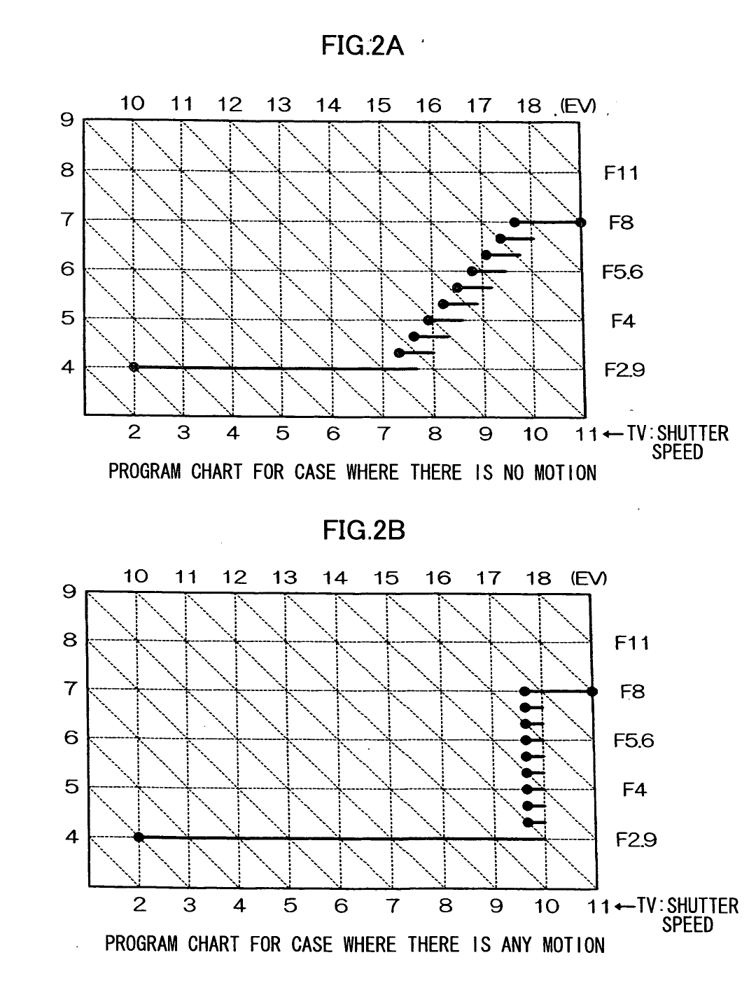

As shown in FIGS. 2A and 2B, the shutter speed at a given EV value in a “program chart for a case where there is any motion (FIG. 2B)” is set to be faster than that at the given EV value in a “program chart for a case where there is no motion (FIG. 2A).” As described above, by setting the digital camera 10 such that the shutter speed becomes faster when there is any motion, blurring of an image photographed can be effectively suppressed.

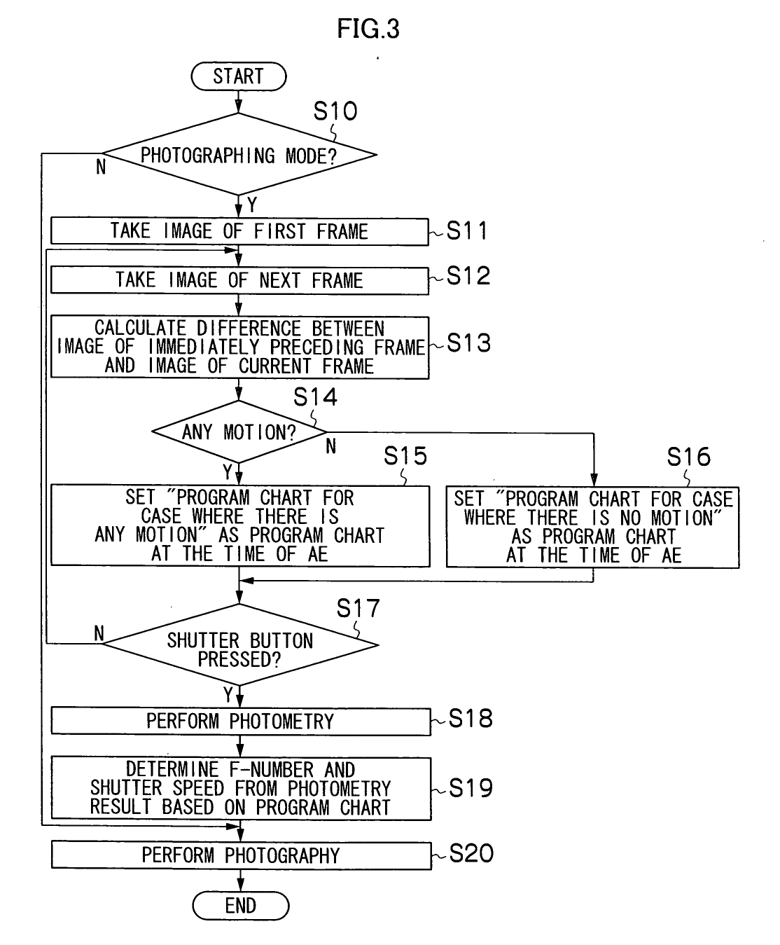

FIG. 3 is a flowchart showing the procedure for processing at the time of photography with the digital camera 10 of this embodiment.

First, the CPU 42 determines on the basis of an input from the operation unit 44 whether the mode of the camera is set to a photographing mode (step S10). If the CPU 42 determines that the mode is set to the photographing mode, an image of the first frame is taken by the image sensor 14 (step S11). Image signals obtained from the image sensor 14 are subjected to predetermined signal processing, converted into YUV data, and stored in the buffer memory of the motion detection unit 40.

After a lapse of a predetermined time from the taking of the image of the first frame, an image of the next frame is taken with the image sensor 14 (step S12). Image signals obtained from the image sensor 14 are subjected to the predetermined signal processing, converted into YUV data, and stored in the buffer memory of the motion detection unit 40. Note that an image taking interval at this time is set to be equal to that (e.g., every 1/30 second) for displaying a through image on the LCD monitor 30.

After the image of the next frame is taken, the motion detection unit 40 calculates a difference value between the image of the next frame and the image of the immediately preceding frame (step S13). The CPU 42 detects motion of an image on the basis of the difference value calculated by the motion detection unit 40. More specifically, the CPU 42 determines whether the difference value obtained from the motion detection unit 40 exceeds the preset threshold value, thereby determining the presence or absence of motion (image blurring) of the image (step S14).

If it is determined that there is any image motion, the CPU 42 sets the “program chart for a case where there is any motion” as the program chart to be used at the time of AE (step S15). On the other hand, if it is determined that there is no image motion, the CPU 42 sets the “program chart for a case where there is no motion” as the program chart to be used at the time of AE (step S16).

After that, the CPU 42 determines on the basis of an input from the operation unit 44 whether the shutter button has been pressed (step S17). If it is determined that the shutter button has been pressed, the CPU 42 meters the brightness of a subject (step S18). The CPU 42 determines the f-number and shutter speed from the photometry result on the basis of the set program chart (step S19) and performs photography (step S20). More specifically, the CPU 42 exposes the image sensor 14 to light with the determined f-number at the determined shutter speed, processes obtained image signals, and records them on the storage medium 34.

If it is determined in step S117 that the shutter button has not been pressed, the flow returns to the process in step S12 to take an image of a frame after the next one. Then, a difference between the image of the frame and an image of the immediately preceding frame is calculated (step S13), and the presence or absence of motion is detected.

As described above, in the digital camera 10 of this embodiment, if there is any motion (image blurring) of an image taken by the image sensor 14, the program chart to be used is automatically switched from the current one to another such that the shutter speed becomes faster. Accordingly, blurring of an image taken can be effectively suppressed.

Since motion of an image is detected on the basis of an output from the image sensor 14, a detection device such as an acceleration sensor need not be provided, and the configuration of the apparatus can be simplified.

In this embodiment, the two program charts, i.e., one for a case where there is any motion and one for a case where there is no motion are prepared. However, a plurality of program charts to be selected depending on the magnitude of motion of an image (the magnitude of a difference value for the image) may be prepared. More specifically, the program charts may be switched in order depending on the magnitude of the motion of the image (the magnitude of the difference value for the image).

Also, in this embodiment, a case has been explained as an example where the present invention is applied to a digital camera. However, application of the present invention is not limited to this. For example, the present invention can be applied to all image taking apparatuses such as a video camera and a camera-equipped cellular phone handset that each takes an image using an image sensor such as a CCD or CMOS.

What is claimed is:

1. An image taking apparatus which determines an exposure from a photometry result in accordance with a program chart and takes an image by exposing an image sensor to light with the determined exposure, comprising:
a motion detection device which detects motion of an image taken by the image sensor on the basis of images continuously taken by the image sensor; and
a program chart switching device which switches between program charts depending on a magnitude of motion detected by the motion detection device such that a shutter speed becomes faster with respect to a single photometry result.

2. The image taking apparatus according to claim 1, wherein the motion detection device detects the motion of the image taken by the image sensor on the basis of a difference between an image of a current frame and an image of an immediately preceding frame taken by the image sensor.

3. The image taking apparatus according to claim 1, wherein a plurality of program charts to be selected depending on a magnitude of motion detected by the motion detection device are prepared.

4. The image taking apparatus according to claim 2, wherein a plurality of program charts to be selected depending on a magnitude of motion detected by the motion detection device are prepared.
